(19) United States
(12) Patent Application Publication
(10) Pub. No.: US 2025/0156924 A1
(43) Pub. Date: May 15, 2025

(54) INTELLIGENT WORKSPACE SETUP OPTIMIZATION TOOL WITH AI-DRIVEN INTERFACE FOR STREAMLINED TECHNOLOGY CONFIGURATION

(71) Applicant: Matt Archer, Boise, ID (US)

(72) Inventor: Matt Archer, Boise, ID (US)

(21) Appl. No.: 18/506,099

(22) Filed: Nov. 9, 2023

(51) Int. Cl. G06Q 30/0601

(52) U.S. Cl. CPC G06Q 30/0631

(57) ABSTRACT

This system employs artificial intelligence to provide an intelligent and user-friendly interface that guides users through selecting the optimal technology stack for their specific workplace requirements. It's designed to intuitively understand the needs of various professional environments, offering tailored suggestions for hardware and software that can enhance productivity and efficiency. According to a specific aspect of this invention, a computer-implemented method which involves: capturing a multitude of data points reflecting the user's preferences and requirements through mechanisms comprising, surveys, questionnaires, and interviews; Storing said data in a repository constructed for rapid access and analysis; utilizing advanced algorithms to preprocess said data and in turn provide dynamic responses at the user interface and simultaneously generate digital profiles for characterizing individual user preferences; prompting the user to verify or enhance data accuracy and completeness; initiating a dynamic machine learning framework that correlates the continually updated digital profile with a database of technology products and/or services, to produce and display customized recommendations. The invention revolutionizes processes for building and acquiring optimal workplace setups and networks.

### BACKGROUND

The complexity of designing and integrating efficient workplace setups is a significant challenge for modern businesses. Traditional methods are often heuristic and not data driven. These methods falter in handling the multitude of variables involved in creating optimized, efficient, and interconnected networks for businesses at any scale. This inefficiency underscores a crucial market gap and the need for innovative solutions.

Managing computing devices within an organization is known. Prior art patent documents such as U.S. Pat. No. 10,791,442 disclose, for example, system for autonomously monitoring and managing consumer device assets includes a plurality of consumer device assets registered with a remote computer server platform. The remote computer server platform is configured to execute software applications for monitoring and managing the consumer device assets. The consumer device assets communicate operational status information and consumer usage information to the remote computer server platform automatically because of pre-programmed conditions and/or instructions received from the remote computer server platform. The remote computer server platform monitors the consumer device assets by processing the operational status information and consumer usage information automatically according to preprogrammed conditions.

There still exists, however, a need for a system that transcends current limitations by harnessing AI's capabilities to streamline and intuitively adapt workplace setup design processes. Such an innovation would not only remove inefficiencies but also customize configurations in alignment with unique business needs, creating real value on the operational front.

### SUMMARY

Given the existing limitations, the current invention introduces innovative systems and methods that focus on an intuitive process for the collection, analysis, and processing of user data for curating customized product, and service recommendations. This system employs artificial intelligence to provide an intelligent and user-friendly interface that guides users through selecting the optimal technology stack for their specific workplace requirements. It's designed to intuitively understand the needs of various professional environments, offering tailored suggestions for hardware and software that can enhance productivity and efficiency.

According to a specific aspect of this invention, a computer-implemented method which involves: capturing a multitude of data points reflecting the user's preferences and requirements through mechanisms comprising, chats, surveys, questionnaires, and interviews; Storing said data in a repository constructed for rapid access and analysis; utilizing advanced algorithms to preprocess said data and in turn provide dynamic responses at the user interface while simultaneously generating digital profiles for characterizing individual user preferences; prompting the user to verify or enhance data accuracy and completeness; initiating a dynamic machine learning framework that correlates the continually updated digital profile with a database of technology products and services, to produce customized recommendations; displaying said recommendations to the user as a set of results, said set comprising visual data, textual data, or an environmental simulation interface with capabilities to allow for advanced visualizations.

In an additional aspect, the invention encompasses: one or more Input/Output devices connected to a user interface; a data storage system integrated on a computer-readable medium; and at least one processor programmed to: archive comprehensive user data as structured objects within the said data repository; present interactive prompts to the user for the acquisition of personal preferences comprising, budgetary constraints, desired technical specifications, and anticipated outcomes; calculations by a processor to create refined digital profiles for the user's submitted data; applying one or more machine learning algorithms, to discern patterns, predict user inclinations and identify a set of products and/or services that align with the user's criteria; presenting recommendations of products and/or services to the user in one or many formats; presenting an intuitive interface for the visualization and augmentation of the recommended products and services.

### BRIEF DESCRIPTION OF THE DRAWINGS

FIG. 1 encompasses a series of sub-figures related to the user interface and backend system:

FIG. 1 depicts the flow point for entry to the system through a basic sign-up portal. An optional flow point for entry while incorporating and processing the data associated with the user's LinkedIn account is also depicted.

FIG. 2 depicts the information flow for a chat-like user interface deployed at a computer terminal, prompting the user with a series of questions tailored to assess technology product preferences and requirements. Artificial Intelligence Large Language Models (AI LLMs) will be integrated into the chat-like user interface to enhance the user experience by creating a more natural and engaging conversation, understanding the user's inputs more accurately, and generating better personalized recommendations. This AI-guided interface employs React.js for its frontend development, ensuring a dynamic and responsive user experience.

FIG. 3 depicts the backend structure where user responses are processed. Here, Python, potentially along with machine learning libraries such as TensorFlow or PyTorch, are utilized for real-time data handling and the curation of personalized recommendations. AI LLM's such as ChatGPT are conjointly integrated to enhance backend processing by analyzing user responses in better detail, extracting relevant information, and generating improved user profiles.

FIG. 4 depicts the Digital Room Configurator tool, highlighting its visualization capabilities. This interactive environment allows users to virtually place and arrange technology products within a simulated room.

FIG. 5 depicts the checkout process, detailing the storage of customer data and the option to schedule an installation and implementation of the purchased goods.

### DETAILED DESCRIPTION

Embodiments illustrative of the present invention are described with reference to the attached drawings. Constituents denoted by the same symbols have similar configurations in respective figures.

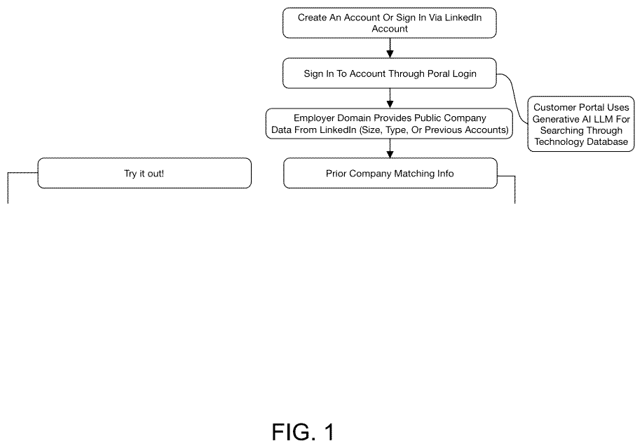

### FIG. 1—User Onboarding

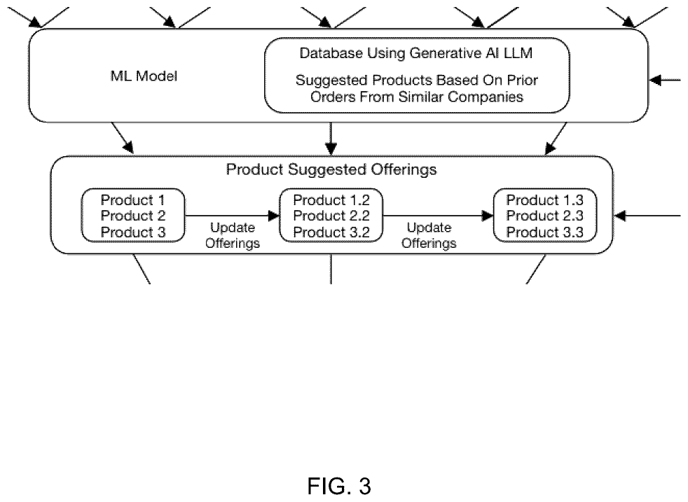

FIG. 1 portrays a basic user onboarding portal designed using web technologies such as HTML5, CSS, and JavaScript frameworks, notably React.js. Application platform interfaces for account sign-in/up on LinkedIn or other networks are incorporated using OAuth SSO or other 3^{rd} party libraries as an optional sign-in/up method to pre-collect data about the user. The pre-collected data is sent to the machine learning model (detailed in FIG. 3) for processing in conjunction with ChatGPT and other AI LLMs. The processed information will be utilized to pre-tailor the information collected during the process which will enhance and expedite the user experience.

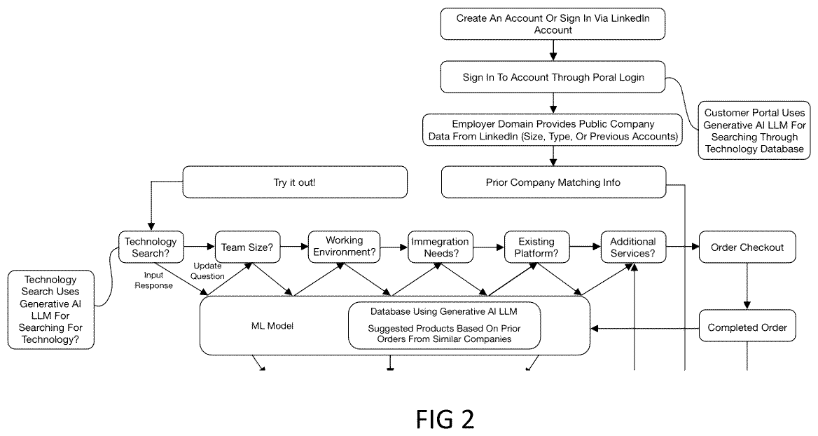

### FIG. 2—User Interface and Backend System

FIG. 1 portrays a conversational user interface, designed using web technologies such as HTML5, CSS, and JavaScript frameworks, notably React.js. The system initiates an AI-powered dialogue, intelligently designed to deduce the user's preferences and requirements for technology products. This process is streamlined and user-friendly, employing ChatGPT and other AI LLMs to enhance the user experience by providing a natural and engaging conversation, understanding the user's intent more accurately, and generating better personalized recommendations.

### FIG. 3—Back-End/Output User Interface

The interface's backend, as shown in FIG. 2. It employs Python's advanced computing capabilities, integrating TensorFlow or PyTorch for any neural network operations essential in processing user inputs. These operations are vital for analyzing textual data, extracting relevant information, and formulating accurate user profiles to generate personalized recommendations.

In this system, user responses are assessed, and relevant metadata is extracted to form the basis of personalized queries within the product database. The Python-based algorithms that can recognize nuanced preferences, ensuring a high degree of personalization in the recommendations provided.

Running in conjunction with these algorithms are ChatGPT and other AI LLMs. These LLMs will enhance the backend processing by analyzing user responses in more detail, extracting more relevant information, and generating more accurate user profiles.

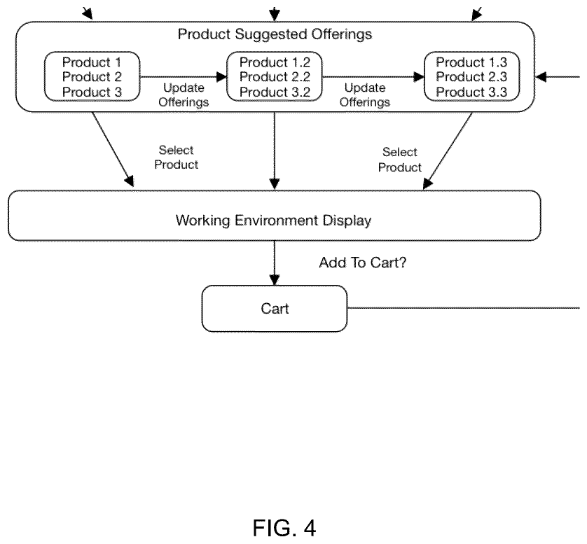

### FIG. 4—Room Configurator

FIG. 3 abstracts the Room Configurator, within this module, individuals can interactively place and visualize products, experimenting with different configurations based on their preferences.

The tool's backend, possibly using Node.js, ensures smooth performance, accurately reflecting real-time user adjustments. This system is especially relevant for users seeking to understand spatial requirements and aesthetic contributions of technology products within a room.

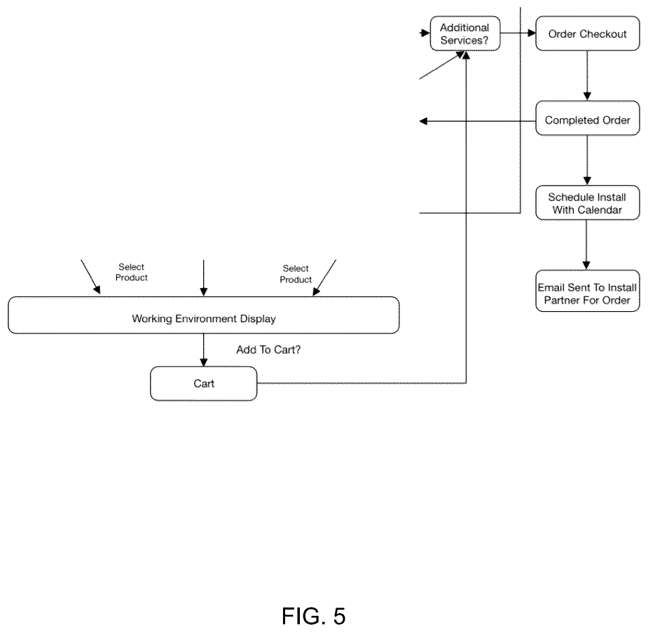

### FIG. 5—Checkout

FIG. 4 depicts the checkout process designed using web technologies such as HTML5, CSS, and JavaScript frameworks, notably React.js. Payment methods are implemented using a 3^{rd} party library. In this case Stripe libraries are utilized. Throughout the checkout process, user information is captured and processed as feedback to further improve the machine learning models.

During the final stages the user is prompted to further engage with the system through the request of accompanied installation and implementation services. Calendly or another type of 3^{rd} party calendaring SaaS solutions will be used for scheduling. After all aspects of the service have been confirmed an email is sent to an install and implementation partner to execute the order.

The described embodiments are for the purpose of facilitating an understanding of the present invention and are not intended to limit the interpretation thereof. Elements and their configurations, methods, and technologies are not limited to the illustrated examples but can be appropriately altered, partially replaced, or combined.

1. A computer-implemented system to optimize user experience for product and service selection for workplace environments comprising: initiating interactive and dynamic user interface(s) to capture the inputs and preferences of a user; storing those inputs as data objects in a repository; processing said data using one or more algorithms for the intricate analysis of the collected data; using the output of the algorithm(s) as real time responses in order to update the UI for further data collection on the user, as well as to dynamically update product-service recommendations for the user; transmitting to the user the responses and recommendations in a set of results, said set comprising visual, textual data, or an intuitive interface with capabilities to allow for advanced visualizations of proposed products-services and user feedback.

2. The method of claim 1, wherein an associated set of data points are captured from a web page associated with the user; said data points are processed using one or more algorithms as described in claim 1; the output of the algorithm based on said data points is used to expedite and further enhance the overall process by pre-capturing and automatically filling necessary data points.

3. The method of claim 1, wherein a natural language processing module or AI LLMs demonstrate adaptive questioning techniques, dynamically adjusting inquiry in real-time based on ongoing user input, to allow for a comprehensive spectrum of user preferences and technical specifications.

4. The method of claim 1, wherein the AI-guided mechanism utilizes machine learning algorithms for predicting possible user actions based on historical and real-time data.

5. The method of claim 1, wherein an environmental simulation module operates on granting users the capacity to visualize their technological habitat by incorporating suggested products

6. The method of claim 4, wherein the immersive environmental simulation module operates on a live three-dimensional visualization framework.

7. The method of claim 1, wherein the ML module integrates advanced deep learning methodologies to discern intricate patterns and proclivities in user feedback and synchronizes these insights with a routinely augmented product database, culminating in the presentation of a personalized catalog of technology products and services.

8. The method of claim 1, wherein the immersive environmental simulation module incorporates functionalities for the preservation and dissemination of virtual technology environment configurations, enabling users to retain a digital record of their conceptual designs and partake in collaborative sharing with other entities.

9. The method of claim 1, wherein supplemental algorithms are provided that calculate differences in efficiencies between recorded environmental configurations.

10. The method of claim 1, wherein upon completion of purchase of the recommended technologies the customer data is recorded and sent to the machine learning models as feedback to further improve the system.

11. The method of claim 1, wherein a partner service for installation and implementation of the recommended and purchased software/hardware stack is offered to the end user.
